(19) United States
(12) Patent Application Publication
(10) Pub. No.: US 2024/0343956 A1
(43) Pub. Date: Oct. 17, 2024

(54) TACKY AGENT-FORMING COMPOSITION AND PRODUCTION METHOD THEREOF, AND TACKY AGENT COMPOSITION

(71) Applicant: DEXERIALS CORPORATION, Tochigi (JP)

(72) Inventors: Kouki HATSUDA, Tochigi (JP); Minoru NAGASHIMA, Tochigi (JP); He YANG, Tochigi (JP); Kaori WAKU, Tochigi (JP); Takeshi NOGUCHI, Tochigi (JP)

(21) Appl. No.: 18/683,435

(22) PCT Filed: Aug. 1, 2022
(86) PCT No.: PCT/JP2022/029564

§ 371 Date: Feb. 13, 2024

(30) Foreign Application Priority Data
Aug. 19, 2021 (JP) 2021-134169

(51) Int. Cl. C09J 167/07; C08G 63/91

(52) U.S. Cl. CPC C09J 167/07; C08G 63/912

(57) ABSTRACT

A tacky agent-forming composition includes a polylactic acid structure-including monofunctional (meth)acrylic monomer, a polylactic acid structure-including polyfunctional (meth)acrylic monomer, and a polylactic acid structure-including non-functional compound. A content of the polylactic acid structure-including non-functional compound is 10% by mole or more.

### TECHNICAL FIELD

The present invention relates to tacky agent-forming compositions and production methods thereof, and enzymatically degradable tacky agent compositions.

### BACKGROUND ART

Plastics are widely used because they are extremely convenient in terms of usability, and are mass-produced. Meanwhile, less than 10% thereof is only re-used after recycling, and about 80% of the plastic wastes is landfilled or discarded in the natural world. The plastic wastes have been a serious social issue, and biodegradable plastics have been researched and developed, and have been put to practical use. Such biodegradable plastics are degraded to water and carbon dioxide by the action of an enzyme released by microorganisms in the natural world.

A tacky agent is a film or sheet having tack (tackiness) and is pasted for use. Meanwhile, an adhesive is liquid before use but is turned into a solid by the action of heat, light, moisture, or the like for bonding. Therefore, the tacky agent is distinguished from the adhesive. The tacky agent is utilized in various industrial fields such as automobiles, packaging materials, building materials, IT fields, agricultural fields, medical fields, DIY-related fields, and the like. Thus, impartment of biodegradability to the tacky agent is expected to lead to reduction in environmental load. Also, for practical use, it is beneficial if the tacky agent is charged to a buffer including an enzyme and can be degraded to water and carbon dioxide through delamination by the action of the enzyme. When the tacky agent is degraded in the natural world or with an artificial compost, facilities and treatments are necessary because the tacky agent is degraded to soil. There is an issue in that it takes a long time taken for the tacky agent to degrade.

The polymer of a tacky sheet generally has a high molecular weight and a low crosslinking density. The glass transition temperature of the polymer is-20° C. or lower. Meanwhile, existing biodegradable plastics are relatively hard, i.e., have a melting point of 50° C. or higher. Such biodegradable plastics have physical properties that are totally opposite to the physical properties of the tacky sheet. Therefore, much effort is required for imparting biodegradability or enzymatic degradability to the tacky sheet.

As the tacky agent composition having biodegradability, it is proposed to make a design to introduce a bulky group in a side chain and achieve stickiness as a physical property of a polymer (a soft elastomer gel having tackiness) (see, for example, PTLs 1 to 6). However, there is an issue that the above tacky agent composition is produced by a very complicated method. Therefore, there is a need for a biodegradable or enzymatically degradable tacky agent composition that can be produced more conveniently and inexpensively. Also, from the viewpoint of reduction in environmental load, it is desired to use no solvent during a production process and to use biomass as a raw material.

### CITATION LIST

### Patent Literature

PTL 1: Japanese Laid-Open Patent Application No. 06-228508
PTL 2: PCT Japanese Translation Patent Publication No. 10-504057
PTL 3: Japanese Laid-Open Patent Application No. 08-218039
PTL 4: Japanese Laid-Open Patent Application No. 11-21533
PTL 5: Japanese Laid-Open Patent Application No. 2001-327520
PTL 6: Japanese Laid-Open Patent Application No. 2002-53828

### SUMMARY OF INVENTION

### Technical Problem

The present invention aims to address the above-described existing issues and achieve the following object. That is, it is an object of the present invention to provide: a tacky agent-forming composition, and a production method thereof, that can impart excellent enzymatic degradability, biodegradability, and tackiness to a tacky agent composition, and can form the tacky agent composition conveniently and inexpensively; and a tacky agent composition that has excellent enzymatic degradability, biodegradability, and tackiness, and can be produced conveniently and inexpensively.

### Solution to Problem

Means for addressing the above issues is as follows.
<1> A tacky agent-forming composition, including:
   a polylactic acid structure-including monofunctional (meth)acrylic monomer;
   a polylactic acid structure-including polyfunctional (meth)acrylic monomer; and
   a polylactic acid structure-including non-functional compound, in which
   a content of the polylactic acid structure-including non-functional compound is 10% by mole or more.
<2> A production method of a tacky agent-forming composition, the production method including:
   reacting (meth)acrylic acid chloride and saturated fatty acid chloride with a polylactic acid structure-including diol.
<3> The production method of the tacky agent-forming composition as described in <2> above, in which
   a molecular weight of the polylactic acid structure-including diol is 1,000 or higher, as measured from a hydroxy value thereof.
<4> A tacky agent composition, including:
   a cured product of the tacky agent-forming composition as described in <1> above.
<5> The tacky agent composition as described in <4> above, in which
   a sol fraction of the tacky agent composition that is acetone soluble is 30% or more.
<6> The tacky agent composition as described in <4> or <5> above, in which
   the tacky agent composition is degraded by an exo-type lipase.

### Advantageous Effects of Invention

The present invention addresses the above-described existing issues and achieves the above object, and can provide: a tacky agent-forming composition, and a production method thereof, that can impart excellent enzymatic degradability, biodegradability, and tackiness to a tacky agent composition, and can form the tacky agent composition conveniently and inexpensively; and a tacky agent composition that has excellent enzymatic degradability, biodegradability, and tackiness, and can be produced conveniently and inexpensively.

### BRIEF DESCRIPTION OF DRAWINGS

FIG. 1 is a graph illustrating a simulation of a mole ratio of a polylactic acid structure-including monofunctional (meth)acrylic monomer, a polylactic acid structure-including polyfunctional (meth)acrylic monomer, a polylactic acid structure-including non-functional compound, or any combination thereof that are reaction products obtained through reaction between the polylactic acid structure-including diol and acrylic acid chloride, propionic acid chloride, or both. The horizontal axis indicates the mole ratio of acrylic acid chloride or propionic acid chloride. The vertical axis indicates the mole ratio of the polylactic acid structure-including monofunctional (meth)acrylic monomer, the polylactic acid structure-including polyfunctional (meth)acrylic monomer, the polylactic acid structure-including non-functional compound, or any combination thereof that are the reaction products. Also, in the graph, gray squares (▪) indicate the polylactic acid structure-including monofunctional (meth)acrylic monomer, blank triangles (Δ) indicate the polylactic acid structure-including polyfunctional (meth)acrylic monomer, and black circles (●) indicate the polylactic acid structure-including non-functional compound.

### DESCRIPTION OF EMBODIMENTS

### (Tacky Agent-Forming Composition)

The tacky agent-forming composition of the present invention includes the polylactic acid structure-including monofunctional (meth)acrylic monomer (hereinafter may be simply referred to as a “monofunctional (meth)acrylic monomer”), the polylactic acid structure-including polyfunctional (meth)acrylic monomer (hereinafter may be simply referred to as a “polyfunctional (meth)acrylic monomer”), and the polylactic acid structure-including non-functional compound (hereinafter may be simply referred to as a “non-functional compound”) and if necessary, further includes other components.

The content of the polylactic acid structure-including non-functional compound in the tacky agent-forming composition is 10% by mole or more.

Note that, in the present specification, “(meth)acrylic” in the terms “(meth)acrylic acid chloride”, “(meth)acrylic monomer”, and “(meth)acrylic group” means both acrylic and methacrylic.

Also, in the present specification, regarding the constituent units of the polylactic acid in the polylactic acid structure-including monofunctional (meth)acrylic monomer, the polylactic acid structure-including polyfunctional (meth)acrylic monomer, and the polylactic acid structure-including non-functional compound, the polylactic acid may be poly-L-lactic acid consisting of L-lactic acid, may be poly-D-lactic acid consisting of D-lactic acid, or may be poly-L, D-lactic acid including both L-lactic acid and D-lactic acid at various mole ratios. Of these, poly-L-lactic acid is preferable.

### <Polylactic Acid Structure-Including Monofunctional (Meth)Acrylic Monomer>

The polylactic acid structure-including monofunctional (meth)acrylic monomer is a monomer including a polylactic acid structure as a backbone and one (meth)acrylic group in the molecule thereof, and is a compound represented by the following general formula (1).

### [Chem. 1]

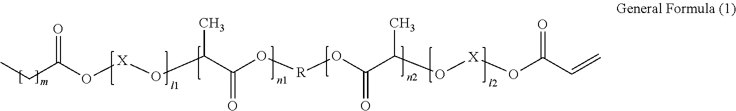

In the above general formula (1), R represents linear or branched alkylene glycol having from 2 through 4 carbon atoms, X represents —(CH₂)₅CO—, and m, n1, n2, 11, and 12 each independently represent an integer. R is preferably butanediol or ethylene glycol, with butanediol being more preferable.

The monofunctional (meth)acrylic monomer includes the polylactic acid structure as the backbone, and thus can impart enzymatic degradability and biodegradability to the tacky agent composition (hereinafter may be referred to as a “cured product”) obtained using the tacky agent-forming composition. There is also an issue that the existing tacky agent compositions become more brittle when the cross-linking density thereof becomes too high. Meanwhile, the tacky agent-forming composition including the monofunctional (meth)acrylic monomer has an advantage that the cross-linking density of the cured product does not become too high and has appropriate tackiness.

Note that, in the present specification, “enzymatic degradability” means degradability by the action of an exo-type lipase that performs degradation from the terminal of a polymer. More specifically, “enzymatic degradability” means that in a state where a substance is immersed at 37° C. under normal pressure for 100 hours in a buffer including a predetermined amount of the exo-type lipase, the mass of that substance changes from the mass thereof before reaction, and the mass change rate thereof is greater than the mass change rate observed with no addition of the exo-type lipase.

Also, in the present specification, “biodegradability” means degradability by the action of an enzyme including the exo-type lipase that is produced by microorganisms widely found in the natural world. Therefore, “enzymatic degradability” and “biodegradability” are only different in where enzymatic reaction occurs, and have the same meaning in terms of actions thereof.

Also, in the present specification, “tackiness” means a force generated by contact between a tacky surface of the tacky agent composition, and an adherend, and a force necessary for peeling off what was pasted.

In the above general formula (1), no particular limitation is imposed on the sum of n1 and n2, which may be appropriately selected in accordance with the intended purpose as long as the sum of n1 and n2 is an integer. However, the sum of n1 and n2 is preferably from 14 through 35 and more preferably from 14 through 30. n1 and n2 may be the same or different.

In the above general formula (1), no particular limitation is imposed on the sum of l1 and l2, which may be appropriately selected in accordance with the intended purpose as long as the sum of l1 and l2 is an integer. However, the sum of l1 and l2 is preferably from 0 through 14 and more preferably from 8 through 11. l1 and l2 may be the same or different.

In the above general formula (1), no particular limitation is imposed on m, which may be appropriately selected in accordance with the intended purpose as long as m is an integer. However, from the viewpoint of viscosity or crystallinity, m is preferably from 1 through 10 and more preferably from 1 through 3.

No particular limitation is imposed on the molecular weight of the monofunctional (meth)acrylic monomer as measured from the hydroxy value thereof, which may be appropriately selected in accordance with the intended purpose. However, when the monofunctional (meth)acrylic monomer is obtained through synthesis, the molecular weight thereof is preferably 2,000 or higher and more preferably from 2,000 through 3,000. When the molecular weight of the monofunctional (meth)acrylic monomer as measured from the hydroxy value thereof is lower than 2,000, the cured product may become harder because the inter crosslinking point molecular weight of the cured product becomes smaller. When the molecular weight thereof is higher than 3,000, it may become wax, not liquid.

In the present specification, no particular limitation is imposed on the measurement method of the molecular weight from the hydroxy value, which may be a publicly known method that has been used and may be appropriately selected in accordance with the intended purpose.

The calculation method of the molecular weight is, for example, a method of calculation using the following formula 1 from a hydroxy value denoted by OHA, the number of hydroxy groups included in a molecule denoted by OHB, and the molecular weight (56.1) of potassium hydroxide. The hydroxy value can be measured according to JIS K 0070:1992. The number of hydroxy groups included in the molecule can be measured through titration with a potassium hydroxide-ethanol solution.

### [Math. 1]

$$Molecular Weight = \frac{56.1 \times {10}^{3} \times {OH}_{B}}{{OH}_{A}} \qquad Formula 1$$

No particular limitation is imposed on the content of the monofunctional (meth)acrylic monomer in the tacky agent-forming composition, which may be appropriately selected in accordance with the content of the polyfunctional (meth)acrylic monomer and the non-functional compound. However, the content of the monofunctional (meth)acrylic monomer is preferably from 40% by mole through 90% by mole and more preferably from 50% by mole through 90% by mole relative to the total content of the monofunctional (meth)acrylic monomer, the polyfunctional (meth)acrylic monomer, and the non-functional compound. When the content of the monofunctional (meth)acrylic monomer is 40% by mole or more or 90% by mole or less, appropriate tackiness can be obtained.

When the content of the monofunctional (meth)acrylic monomer relative to the total content of the monofunctional (meth)acrylic monomer, the polyfunctional (meth)acrylic monomer, and the non-functional compound is less than 40% by mole or is more than 90% by mole, the proportion of the polyfunctional (meth)acrylic monomer and the non-functional compound becomes higher. As a result, the cured product may become too hard or soft, and thus appropriate tackiness may be unable to be obtained.

The monofunctional (meth)acrylic monomer for use may be an appropriately synthesized one or a commercially available product.

No particular limitation is imposed on the synthesis method of the monofunctional (meth)acrylic monomer, which may be appropriately selected in accordance with the intended purpose. However, it is more suitable to synthesize the monofunctional (meth)acrylic monomer by a method described in the production method of the tacky agent-forming composition as described below.

The commercially available product of the monofunctional (meth)acrylic monomer is, for example, Poly(L-lactide), acrylate terminated (product number: 775991, number average molecular weight (Mn): 2,500, available from Sigma-Aldrich).

### <Polylactic Acid Structure-Including Polyfunctional (Meth)Acrylic Monomer>

The polylactic acid structure-including polyfunctional (meth)acrylic monomer is a monomer including a polylactic acid structure as a backbone and two or more (meth)acrylic groups in the molecule thereof.

The polyfunctional (meth)acrylic monomer has the polylactic acid structure as the backbone, and thus can impart enzymatic degradability and biodegradability to the cured product. Also, inclusion of the polyfunctional (meth)acrylic monomer can increase the molecular weight of the cured product, impart appropriate viscosity thereto, and also impart flexibility to the cured product.

No particular limitation is imposed on the number of the (meth)acrylic groups in the polyfunctional (meth)acrylic monomer, which may be appropriately selected in accordance with the intended purpose as long as the number of the (meth)acrylic groups in the polyfunctional (meth)acrylic monomer is two or more. However, the number of the (meth)acrylic groups in the polyfunctional (meth)acrylic monomer is preferably two, and the polyfunctional (meth)acrylic monomer is more preferably a compound represented by the following general formula (2).

### [Chem. 2]

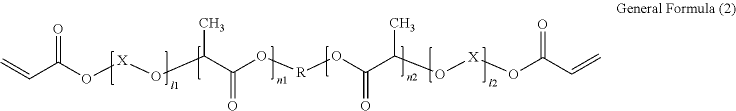

In the above general formula (2), R represents linear or branched alkylene glycol having from 2 through 4 carbon atoms, X represents —(CH₂)₅CO—, and n1, n2, l1, and l2 each independently represent an integer. R is preferably butanediol or ethylene glycol, with butanediol being more preferable.

Also, the polyfunctional (meth)acrylic monomer may include a functional group different from the (meth)acrylic group in the structure thereof as long as the effects of the present invention are not impaired.

No particular limitation is imposed on the functional group, which may be appropriately selected in accordance with the intended purpose. Examples thereof include a vinyl group, an epoxy group, an oxetane group, and the like.

In the above general formula (2), no particular limitation is imposed on the sum of n1 and n2, which may be appropriately selected in accordance with the intended purpose as long as the sum of n1 and n2 is an integer. However, the sum of n1 and n2 is preferably from 14 through 35 and more preferably from 14 through 30. n1 and n2 may be the same or different.

In the above general formula (2), no particular limitation is imposed on the sum of l1 and l2, which may be appropriately selected in accordance with the intended purpose as long as the sum of l1 and l2 is an integer. However, the sum of l1 and l2 is preferably from 0 through 11 and more preferably from 8 through 11. l1 and l2 may be the same or different.

No particular limitation is imposed on the molecular weight of the polyfunctional (meth)acrylic monomer as measured from the hydroxy value thereof, which may be appropriately selected in accordance with the intended purpose. However, when the polyfunctional (meth)acrylic monomer is obtained through synthesis, the molecular weight thereof is preferably 2,000 or higher and more preferably from 2,000 through 3,000. When the molecular weight of the polyfunctional (meth)acrylic monomer as measured from the hydroxy value thereof is lower than 2,000, the cured product becomes harder and may be unable to exhibit sufficient tacky property and a sufficient tackiness retention force.

No particular limitation is imposed on the content of the polyfunctional (meth)acrylic monomer in the tacky agent-forming composition, which may be appropriately selected in accordance with the intended purpose. However, the content of the polyfunctional (meth)acrylic monomer is preferably from 0.1% by mole through 50% by mole, more preferably from 1% by mole through 30% by mole, and especially preferably from 0.5% by mole through 30% by mole relative to the total content of the monofunctional (meth)acrylic monomer, the polyfunctional (meth)acrylic monomer, and the non-functional compound. When the content of the polyfunctional (meth)acrylic monomer is less than 0.1% by mole, the crosslinking density decreases upon curing, and the cured product may be unable to have a sufficient tackiness retention force. When the content of the polyfunctional (meth)acrylic monomer is more than 50% by mole, the crosslinking density of the cured product increases, and sufficient tacky property and sufficient tackiness may be unable to be obtained.

The polyfunctional (meth)acrylic monomer for use may be an appropriately synthesized one or a commercially available product.

No particular limitation is imposed on the synthesis method of the polyfunctional (meth)acrylic monomer, which may be appropriately selected in accordance with the intended purpose. However, it is more suitable to synthesize the polyfunctional (meth)acrylic monomer by a method described in the production method of the tacky agent-forming composition as described below.

### <Polylactic Acid Structure-Including Non-Functional Compound>

The polylactic acid structure-including non-functional compound is a monomer including a polylactic acid structure as a backbone and two or more saturated hydrocarbon groups in the molecule thereof. The polylactic acid structure-including non-functional compound is a compound represented by the following general formula (3).

### [Chem. 3]

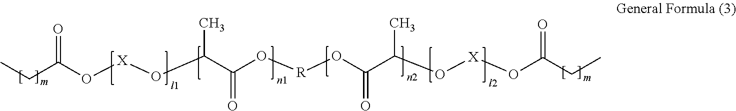

In the above general formula (3), R represents linear or branched alkylene glycol having from 2 through 4 carbon atoms, X represents —(CH₂)₅CO—, and m, n1, n2, l1, and l2 each independently represent an integer. R is preferably butanediol or ethylene glycol, with butanediol being more preferable.

Generally, general-purpose acrylic tacky agent compositions include a monofunctional acrylate, a polyfunctional acrylate, and a tackifier (plasticizer). When a tackifier is included in such general-purpose acrylic tacky agent compositions, resulting general-purpose acrylic tacky agent compositions become closer to be in the form of liquid and thus have increased tacky property. However, the aggregation force thereof becomes smaller and as a result the tackiness retention force thereof becomes smaller. Meanwhile, in the tacky agent-forming composition, the non-functional compound has an action as the tackifier. Therefore, the tacky agent composition (cured product) obtained using the tacky agent-forming composition has an advantage of having an appropriate tackiness retention force, also favorable tacky property and tackiness without addition of a publicly known tackifier, and further the ability to exhibit favorable enzymatic degradability and biodegradability.

In the above general formula (3), no particular limitation is imposed on the sum of n1 and n2, which may be appropriately selected in accordance with the intended purpose as long as the sum of n1 and n2 is an integer. However, the sum of n1 and n2 is preferably from 14 through 35 and more preferably from 14 through 30. n1 and n2 may be the same or different.

In the above general formula (3), no particular limitation is imposed on the sum of l1 and l2, which may be appropriately selected in accordance with the intended purpose as long as the sum of l1 and l2 is an integer. However, the sum of l1 and l2 is preferably from 0 through 11 and more preferably from 8 through 11. l1 and l2 may be the same or different.

In the above general formula (3), no particular limitation is imposed on m, which may be appropriately selected in accordance with the intended purpose as long as m is an integer. However, from the viewpoint of viscosity or crystallinity, m is preferably from 1 through 6 and more preferably from 1 through 4.

No particular limitation is imposed on the molecular weight of the non-functional compound as measured from the hydroxy value thereof, which may be appropriately selected in accordance with the intended purpose. However, when the non-functional compound is obtained through synthesis, the molecular weight thereof is preferably 1,000 or higher and more preferably from 1,000 through 3,000. When the molecular weight of the non-functional compound as measured from the hydroxy value thereof is lower than 1,000, the non-functional compound is not retained in the cured product due to low viscosity thereof, and may outflow from the cured product.

The content of the non-functional compound in the tacky agent-forming composition is 10% by mole or more, preferably from 10% by mole through 30% by mole, and more preferably from 20% by mole through 30% by mole relative to the total content of the monofunctional (meth)acrylic monomer, the polyfunctional (meth)acrylic monomer, and the non-functional compound. When the content of the non-functional compound is less than 10% by mole, the cured product cannot have sufficient tacky property and tackiness, and enzymatic degradability and biodegradability. Also, when the content of the non-functional compound is more than 30% by mole, the cured product may be unable to have a sufficient tackiness retention force, or the non-functional compound may outflow from the cured product.

The non-functional compound for use may be an appropriately synthesized one or a commercially available product.

No particular limitation is imposed on the synthesis method of the non-functional compound, which may be appropriately selected in accordance with the intended purpose. However, it is more suitable to synthesize the non-functional compound by a method described in the production method of the tacky agent-forming composition as described below.

No particular limitation is imposed on the total content of the monofunctional (meth)acrylic monomer, the polyfunctional (meth)acrylic monomer, and the non-functional compound in the tacky agent-forming composition, and the total content thereof may be appropriately selected in accordance with the intended purpose. The tacky agent-forming composition may consist of the monofunctional (meth)acrylic monomer, the polyfunctional (meth)acrylic monomer, and the non-functional compound.

### <Other Components>

No particular limitation is imposed on the other components in the tacky agent-forming composition, which may be appropriately selected in accordance with the intended purpose as long as the effects of the present invention are not impaired. Examples thereof include polymerization initiators, solvents, porous materials, foaming agents, dyes, pigments, inorganic fillers, biodegradable resin particles, and various additives such as softeners, anti-aging agents, anti-oxidants, stabilizers, fungicides, thickeners, colorants, defoamers, adhesion improvers, and the like. Also, monomer components other than the monofunctional (meth)acrylic monomer, the polyfunctional (meth)acrylic monomer, and the non-functional compound (hereinafter may be referred to as “other monomer components”) may be included. These may be used alone or in combination.

No particular limitation is imposed on the polymerization initiators, which may be appropriately selected from publicly known ones. Examples thereof include photopolymerization initiators and thermal polymerization initiators. These may be used alone or in combination.

Examples of the photopolymerization initiators include acetophenone, 2,2-diethoxyacetophenone, p-dimethylaminoacetophenone, benzophenone, 2-chlorobenzophenone, p,p′-dichlorobenzophenone, p,p-bisdiethylaminobenzophenone, Michler's ketone, benzyl, benzoin, benzoin methyl ether, benzoin ethyl ether, benzoin isopropyl ether, benzoin-n-propyl ether, benzoin isobutyl ether, benzoin-n-butyl ether, benzyl methyl ketal, thioxanthone, 2-chlorothioxanthone, 2-hydroxy-2-methyl-1-phenyl-1-one, 1-(4-isopropylphenyl) 2-hydroxy-2-methylpropan-1-one, methyl benzoylformate, 1-hydroxycyclohexyl phenyl ketone, azobisisobutyronitrile, benzoyl peroxide, di-tert-butyl peroxide, and the like. These may be used alone or in combination.

Examples of the thermal polymerization initiators include azo-based initiators, peroxide initiators, persulfate initiators, redox (oxidoreduction) initiators, and the like. These may be used alone or in combination.

The azo-based initiators for use may be a commercially available product. Examples of the commercially available product include VA-044, VA-46B, V-50, VA-057, VA-061, VA-067, VA-086, 2,2′-azobis(4-methoxy-2,4-dimethylvaleronitrile) (VAZO 33), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64), 2,2′-azobis-2-methylbutyronitrile (VAZO 67), 1,1-azobis(1-cyclohexanecarbonitrile) (VAZO 88) (all of which are available from DuPont Chemical; note that, “VAZO” is a trademark), and 2,2′-azobis(2-cyclopropylpropionitrile) and 2,2′-azobis(methyl isobutyrate) (V-601) (available from FUJIFILM Wako Pure Chemical Corporation), and the like.

Examples of the peroxide initiators include benzoyl peroxide, acetyl peroxide, lauroyl peroxide, decanoyl peroxide, dicetyl peroxydicarbonate, di(4-t-butylcyclohexyl) peroxydicarbonate (Perkadox 16S) (available from Akzo Nobel; note that, “Perkadox” is a trademark), di(2-ethylexyl) peroxydicarbonate, t-butylperoxypivalate (Lupersol 11) (available from Elf Atochem; note that, “Lupersol” is a trademark), t-butylperoxy-2-ethylhexanoate (Trigonox 21-C50) (available from Akzo Nobel; note that, “Trigonox” is a trademark), dicumyl peroxide, and the like.

Examples of the persulfate initiators include potassium persulfate, sodium persulfate, and ammonium persulfate.

Examples of the redox (oxidoreduction) initiators include: combinations of the persulfate initiators and reducing agents such as sodium metabisulfite, sodium hydrogensulfite, and the like; systems based on organic peroxides and tertiary amines, such as a system based on benzoyl peroxide and dimethylaniline, a system based on organic hydroperoxide and a transition metal, and a system based on cumene hydroperoxide and cobalt naphthenate, and the like.

No particular limitation is imposed on the content of the polymerization initiator in the tacky agent-forming composition, which may be appropriately selected in accordance with the intended purpose.

No particular limitation is imposed on the solvent, which may be appropriately selected from publicly known ones. Examples thereof include water, acetone, methanol, ethanol, isopropyl alcohol, tetrahydrofuran, methyl ethyl ketone, ethyl acetate, butyl acetate, methylene chloride, and the like. These may be used alone or in combination.

No particular limitation is imposed on the content of the solvent in the tacky agent-forming composition, which may be appropriately selected in accordance with the intended purpose.

No particular limitation is imposed on the porous material, which may be appropriately selected in accordance with the intended purpose as long as the porous material is a material with porosity that can be used as a filler. Inclusion of the porous material increases hardness of the cured product. In addition, upon degradation, an enzyme readily functions from the porous region, and can increase enzymatic degradability and biodegradability.

Examples of the porous material include diatomaceous earth, zeolite, activated carbon, and the like.

No particular limitation is imposed on the content of the porous material in the tacky agent-forming composition, which may be appropriately selected in accordance with the intended purpose.

The foaming agent is a material that is included in the tacky agent-forming composition and is allowed to foam upon curing, thereby enabling the cured product to be porous. By making the cured product porous by the action of the foaming agent, it is possible to increase enzymatic degradability and biodegradability of the cured product.

Examples of the foaming agent include azodicarbonamide, N,N′-dinitropentamethylenetetramine, 4,4′-oxybisbenzenesulfonyl hydrazide, hydrogen carbonate, carbonates, and the like.

No particular limitation is imposed on the content of the foaming agent in the tacky agent-forming composition, which may be appropriately selected in accordance with the intended purpose.

No particular limitation is imposed on the biodegradable resin particles, which may be appropriately selected in accordance with the intended purpose as long as the biodegradable resin particles are particles of a resin that exhibits enzymatic degradability or biodegradability. Inclusion of such enzymatically degradable or biodegradable resin particles in the tacky agent-forming composition enables the cured product to be readily finely divided upon degradation. That is, when the tacky agent-forming composition includes the enzymatically degradable or biodegradable particles, these particles are where degradation starts, and enable the cured product to be finely divided and to have a large surface area. This can increase enzymatic degradability or biodegradability. Also, by finely dividing a mass of the cured product, it is possible to produce enzymatically degradable or biodegradable particles (e.g., beads used for bead-firing replica guns).

Examples of the material of the enzymatically degradable or biodegradable resin particles include polylactic acid, polycaprolactone, and the like.

No particular limitation is imposed on the volume average particle diameter of the enzymatically degradable or biodegradable resin particles, which may be appropriately selected in accordance with the intended purpose. However, the volume average particle diameter thereof is preferably 5 μm or more and 1 mm or less.

No particular limitation is imposed on the content of the enzymatically degradable or biodegradable resin particles in the tacky agent-forming composition, which may be appropriately selected in accordance with the intended purpose.

No particular limitation is imposed on the other polymer components, which may be appropriately selected in accordance with the intended purpose as long as the effects of the present invention are not impaired and the other polymer components are co-polymerizable with the monofunctional (meth)acrylic monomer or the polyfunctional (meth)acrylic monomer. Examples thereof include rosin, dammar, modified rosin, derivatives of rosin or modified rosin, polyterpene-based resins, terpene-modified products, aliphatic hydrocarbon resins, cyclopentadiene resins, aromatic petroleum resins, phenolic resins, alkylphenol-acetylene-based resins, styrene-based resins, coumarone-indene resins, xylene resins, vinyltoluene-α methylstyrene copolymers, hydrogenated styrene-based resins, and the like. Also, a non-functional compound other than the polylactic acid structure-including non-functional compound may be included. These may be used alone or in combination.

No particular limitation is imposed on the content of the other monomer components in the tacky agent-forming composition, which may be appropriately selected in accordance with the intended purpose.

No particular limitation is imposed on the viscosity (mPa·s) of the tacky agent-forming composition, which may be appropriately selected in accordance with the intended purpose. The viscosity thereof at 25° C. is preferably 3,000 mPa·s or higher and 30,000 mPa·s or lower and more preferably 10,000 mPa·s or higher and 20,000 mPa·s or lower.

The glass transition temperature (Tg, ° C.) of the tacky agent-forming composition is preferably equal to or lower than room temperature (20±15° C.), more preferably −5° C. or lower, and especially preferably-10° C. or lower. When the glass transition temperature (Tg, ° C.) is −10° C. or lower, the cured product can have sufficient tackiness.

The glass transition temperature (Tg, ° C.) of the tacky agent-forming composition can be measured by a dynamic mechanical analyzer (DMA: Dynamic Mechanical Analysis, product name: RSA-3, available from TA Instruments). Specifically, the glass transition temperature (Tg, ° C.) is defined as a temperature at the maximum point of tan δ (loss modulus/storage modulus) obtained under measurement conditions of a sample size of 5 mm wide×20 mm long and a frequency of 1 MHZ.

The tacky agent-forming composition is liquid at normal temperature and normal pressure, and is used for production of the tacky agent composition and can be cured by the action of heat, light, or the like. The tacky agent-forming composition can impart excellent enzymatic degradability, biodegradability, and tackiness to the tacky agent composition obtained therefrom. In addition, the tacky agent-forming composition can form the tacky agent composition conveniently and inexpensively, and thus is suitably used for production of the tacky agent composition.

### (Production Method of the Tacky Agent-Forming Composition)

The production method of the tacky agent-forming composition of the present invention includes a step of reacting (meth)acrylic acid chloride and saturated fatty acid chloride with the polylactic acid structure-including diol (hereinafter this step may be referred to as a “reaction step”) and if necessary, further includes other steps.

The production method of the tacky agent-forming composition has an advantage of being able of produce the tacky agent-forming composition conveniently and inexpensively.

### <Reaction Step>

The reaction step is a step of reacting (meth)acrylic acid chloride and saturated fatty acid chloride with the polylactic acid structure-including diol.

### <<Polylactic Acid Structure-Including Diol>>

The polylactic acid structure-including diol for use may be an appropriately synthesized one or a commercially available product.

As the commercially available product of the polylactic acid structure-including diol, examples thereof include, as product names, PLA2205 and PLA2105 (both of which are available from Shenzhen ESUN Industrial Co., Ltd.), and the like. These may be used alone or in combination.

No particular limitation is imposed on the molecular weight of the polylactic acid structure-including diol as measured from the hydroxy value thereof, which may be appropriately selected in accordance with the intended purpose. The molecular weight of the polylactic acid structure-including diol is preferably 2,000 or higher and more preferably from 2,000 through 2,500.

### << (Meth)Acrylic Acid Chloride>>

The (meth)acrylic acid chloride for use may be an appropriately synthesized one or a commercially available product.

### <<Saturated Fatty Acid Chloride>>

No particular limitation is imposed on the saturated fatty acid chloride, which may be appropriately selected in accordance with the intended purpose. Examples thereof include formic acid chloride, acetic acid chloride, propionic acid chloride, butanoic acid chloride, butyric acid chloride, valeric acid chloride, isovaleric acid chloride, hexanoic acid chloride, pivalic acid chloride, caproic acid chloride, enanthic acid chloride, caprylic acid chloride, pelargonic acid chloride, capric acid chloride, undecylic acid chloride, lauric acid chloride, tridecylic acid chloride, myristic acid chloride, pentadecylic acid chloride, palmitic acid chloride, margaric acid chloride, stearic acid chloride, nonadecylic acid chloride, arachidic acid chloride, and the like. These saturated fatty acid chlorides may be used alone or in combination. Of these, propionic acid chloride is preferable.

The saturated fatty acid chloride for use may be an appropriately synthesized one or a commercially available product.

No particular limitation is imposed on the reaction conditions (e.g., reaction temperature, reaction time, and reaction solvent) in the reaction step, which may be appropriately selected from publicly known ones in accordance with the intended purpose.

The reaction temperature is, for example, from −10° C. through 15° C.

The reaction time is, for example, from 3 hours through 10 hours.

The reaction solvent is, for example, tetrahydrofuran, acetone, methylene chloride, dimethylformamide, or the like.

In the reaction step, a mixture of the polylactic acid structure-including monofunctional (meth)acrylic monomer, the polylactic acid structure-including polyfunctional (meth)acrylic monomer, and the polylactic acid structure-including non-functional compound is obtained.

The monofunctional (meth)acrylic monomer, the polyfunctional (meth)acrylic monomer, and the non-functional compound are as described in the above section (Tacky agent-forming composition).

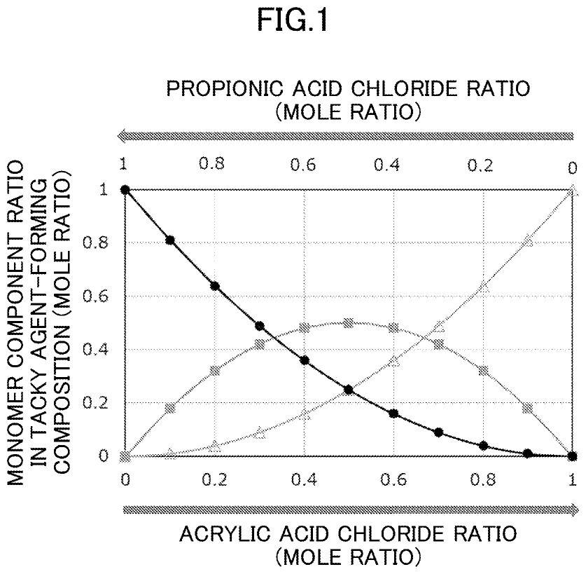

When in the reaction step, propionic acid chloride is used as the saturated fatty acid chloride, acrylic acid chloride and propionic acid chloride have the same reactivity, and thus the mole ratio in the monofunctional (meth)acrylic monomer, the polyfunctional (meth)acrylic monomer, and the non-functional compound, which are reaction products, can be simulated through calculation. As illustrated in FIG. 1, for example, when 0% by mole (mole ratio=0) of propionic acid chloride is used relative to 100% by mole (mole ratio=1) of acrylic acid chloride, a resulting reaction product is 100% by mole (mole ratio=1) of the polyfunctional (meth)acrylic monomer. Also, when 0% by mole (mole ratio=0) of acrylic acid chloride is used relative to 100% by mole (mole ratio=1) of propionic acid chloride, a resulting reaction product is 100% by mole (mole ratio=1) of the non-functional compound. Also, when 50% by mole of acrylic acid chloride and 50% by mole of propionic acid chloride are used, the monofunctional (meth)acrylic monomer:the polyfunctional (meth)acrylic monomer:the non-functional compound is 1:2:1 (mole ratio).

The mixture of the monofunctional (meth)acrylic monomer, the polyfunctional (meth)acrylic monomer, and the non-functional compound obtained in the reaction step can be confirmed through analysis with a liquid chromatography-mass spectrometer (LC-MS) (see, for example, Japanese Laid-Open Patent Application No. 2008-120980), a Fourier transform infrared spectrophotometer (FT-IR), or the like.

For the analysis with FT-IR, specifically, when the monofunctional (meth)acrylic monomer, the polyfunctional (meth)acrylic monomer, and the non-functional compound are synthesized from the polylactic acid structure-including diol that is the reaction material, a peak of a hydroxy group (OH) in the range of from 3, 200 cm⁻¹ through 3,700 cm⁻¹ through FT-IR analysis (a peak of the hydroxy group derived from the polylactic acid structure-including diol) disappears, and a peak of a double bond near 1, 625 cm⁻¹ (a peak of the double bond derived from an acrylic group in the monofunctional (meth)acrylic monomer and the polyfunctional (meth)acrylic monomer) can be observed. The mixture of the monofunctional (meth)acrylic monomer, the polyfunctional (meth)acrylic monomer, and the non-functional compound is excellent in stability to humidity because of the absence of the hydroxy group therein.

### <Other Steps>

No particular limitation is imposed on the other steps, which may be appropriately selected in accordance with the intended purpose. Examples thereof include a solvent-removing step, a purification step, and the like.

### <<Solvent-Removing Step>>

The solvent-removing step is a step of removing the reaction solvent after the reaction step.

No particular limitation is imposed on the method of removing the reaction solvent, which may be appropriately selected in accordance with the intended purpose. Examples thereof include a method of removing the reaction solvent using an evaporator, and the like.

### <<Purification Step>>

The purification step is a step of removing impurities from the mixture obtained in the reaction step.

No particular limitation is imposed on the method of removing impurities, which may be appropriately selected in accordance with the intended purpose. Examples thereof include: a method by suction filtration; a method including leaving the mixture to stand for a long period of time and then obtaining precipitates through decantation of a supernatant; and the like.

By the above-described method, the tacky agent-forming composition can be obtained. The production method of the tacky agent-forming composition has an advantage of being able to produce the tacky agent-forming composition conveniently and inexpensively.

### (Tacky Agent Composition)

The tacky agent composition of the present invention is formed by curing the tacky agent-forming composition of the present invention.

Therefore, the monomer components forming the copolymer in the tacky agent composition are the polylactic acid structure-including monofunctional (meth)acrylic monomer, the polylactic acid structure-including polyfunctional (meth)acrylic monomer, and the polylactic acid structure-including non-functional compound. Thereby, the tacky agent composition has excellent enzymatic degradability, biodegradability, and tackiness.

As described above, enzymatic degradability of the tacky agent composition is degradability by the action of the exo-type lipase that performs degradation from the terminal of a polymer. That is, the crosslinked portion in the tacky agent composition is not degraded by the exo-type lipase, and what is called a sol component is only degraded.

Many studies have been made on the difference in degradation speed between a crystalline region and an amorphous region in plastics (see, for example, C. DelRe et al., “Near-complete depolymerization of polyesters with nano-dispersed enzymes”, Nature, 2021, 592, pp. 558-563). However, because a polymer having a crosslinked structure has no polymer terminal, such a polymer is degraded only by an endo-type enzyme. Disadvantageously, endo-type enzymes have a degradation speed slower than in exo-type enzymes.

Meanwhile, the non-functional compound forming the tacky agent composition not only functions as a tackifier, but also can be degraded by the exo-type lipase that performs degradation at a relatively high speed in terms of lipase degradation ability. Thereby, the tacky agent composition is increased in enzymatic degradability and biodegradability compared to the existing tacky agent composition.

No particular limitation is imposed on the enzymatic degradation rate of the tacky agent composition by the action of the exo-type lipase as long as in a state where the tacky agent composition is immersed at 37° C. under normal pressure for 100 hours in a buffer solution including a predetermined amount of the exo-type lipase, the mass of the tacky agent composition changes from the mass thereof before reaction, and the mass change rate thereof is greater than the mass change rate observed with no addition of the exo-type lipase. The enzymatic degradation rate thereof is preferably 15% or higher, more preferably 20% or higher, and especially preferably 30% or higher.

No particular limitation is imposed on the mole ratio of the monomer components in the tacky agent composition, which may be appropriately selected in accordance with the intended purpose. However, the monofunctional (meth)acrylic monomer:the polyfunctional (meth)acrylic monomer:the non-functional compound is preferably from 0.4:0.3:0.3 through 0.9:0.05:0.05 and more preferably from 0.7:0.1:0.2 through 0.5:0.25:0.25. When the mole ratio is in the preferable range, the tacky agent composition is favorable in enzymatic degradability, biodegradability, and tackiness. A range in which the tacky agent composition can be synthesized by simultaneously using acrylic acid chloride and fatty acid chloride, which are raw materials for synthesis of the tacky agent composition, is as illustrated in FIG. 1.

The tacky agent composition can also be produced by formulating a separately synthesized polylactic acid structure-including monofunctional (meth)acrylic monomer or a commercially available polylactic acid structure-including monofunctional (meth)acrylic monomer (e.g., Poly(L-lactide), acrylate terminated, product number: 775991, number average molecular weight (Mn): 2,500, available from Sigma-Aldrich) and can be increased in properties such as enzymatic degradability, biodegradability, tackiness, and the like.

No particular limitation is imposed on the storage modulus (E′) of the tacky agent composition, which may be appropriately selected in accordance with the intended purpose. However, the storage modulus thereof at 25° C. is preferably 100,000 Pa or higher and 600,000 Pa or lower and more preferably 120,000 Pa or higher and 290,000 Pa or lower.

The storage modulus (E′) of the tacky agent composition can be measured by a dynamic mechanical analyzer (DMA: Dynamic Mechanical Analysis, product name: RSA-3, available from TA Instruments).

No particular limitation is imposed on the loss modulus (E″) of the tacky agent composition, which may be appropriately selected in accordance with the intended purpose. However, the loss modulus thereof at 25° C. is preferably 500 Pa or higher and 50,000 Pa or lower and more preferably 1,000 Pa or higher and 10,000 Pa or lower.

The loss modulus (E″) of the tacky agent composition can be measured by a dynamic mechanical analyzer (DMA: Dynamic Mechanical Analysis, product name: RSA-3, available from TA Instruments).

The inter crosslinking point molecular weight (Mc) is means for expressing the crosslinking density of the tacky agent composition as a numerical value. No particular limitation is imposed on the inter crosslinking point molecular weight (Mc) of the tacky agent composition, which may be appropriately selected in accordance with the intended purpose. However, the inter crosslinking point molecular weight (Mc) of the tacky agent composition is preferably from 5,000 through 30,000 and more preferably from 10,000 through 25,000. When the inter crosslinking point molecular weight (Mc) thereof is lower than 5,000, the tacky agent composition may have poor tackiness because of the high crosslinking density thereof. When the inter crosslinking point molecular weight (Mc) thereof is higher than 30,000, the tacky agent composition may have an insufficient tackiness retention force because of softness thereof.

The inter crosslinking point molecular weight (Mc) is calculated in accordance with the following formula 2 from rubber equilibrium modulus E′ and physical density (d) at a temperature that is equal to or higher than the above Tg of the tacky agent-forming composition.

The crosslinking density is low when the inter crosslinking point molecular weight (Mc) is high. Conversely, the crosslinking density is high when the inter crosslinking point molecular weight (Mc) is low.

### [Math. 2]

$${E}^{′} = \frac{dRT}{Mc} \qquad Formula 2$$

In formula 2, “E′” denotes a rubber equilibrium modulus at a temperature that is equal to or higher than the glass transition temperature (Tg, ° C.) of the tacky agent-forming composition, “d” denotes a density (g/m³) of the tacky agent composition, “R” denotes a gas constant (8.314 J/K/mol) in an ideal gas state equation, and “T” denotes an absolute temperature (K) at the local minimum of E′.

“E′” in formula 2 can be measured by a dynamic mechanical analyzer (DMA: Dynamic Mechanical Analysis, product name: RSA-3, available from TA Instruments).

“d” in formula 2 can be calculated in accordance with the following formula 3.

d=Weight÷Volume Formula 3

In formula 3, “Weight” is a weight measured by preparing a sample of the tacky agent composition cut out into a square of 1 cm per side and weighing the prepared sample with a precision balance, and “Volume” is a volume calculated by measuring the thickness of the sample.

No particular limitation is imposed on the sol fraction of the tacky agent composition that is acetone soluble, which may be appropriately formed into a desired shape in accordance with the intended purpose. However, the sol fraction of the tacky agent composition is preferably 30% or higher, more preferably 40% or higher, and especially preferably 50% or higher. From the viewpoint of the tackiness retention force, the upper limit of the sol fraction of the tacky agent composition that is acetone soluble is preferably 90% or lower, more preferably 80% or lower, and especially preferably 70% or lower. The lower limit and the upper limit of the sol fraction of the tacky agent composition that is acetone soluble can be appropriately combined. For example, the range of from 30% through 70% is preferable, the range of from 40% through 70% is more preferable, and the range of from 50% through 70% is especially preferable.

In the present specification, “sol fraction” is a value calculated in accordance with the following formula 4 from an acetone-soluble component of the tacky agent composition. The acetone-soluble component of the tacky agent composition is obtained by placing the tacky agent composition in acetone, followed by airtightly sealing and being left to stand at room temperature for one week.

Sol fraction (%)=(Initial mass−Mass after treatment with acetone)/Initial mass×100 Formula 4

No particular limitation is imposed on the shape of the tacky agent composition, which may be appropriately formed into a desired shape in accordance with the intended purpose. Examples of the shape thereof include a film shape, a sheet shape, a tape shape, and the like. In the following, the tacky agent composition having such a shape may be referred to as a “shaped product”. Note that, the shaped product is also in the scope of the present invention.

No particular limitation is imposed on the production method of the tacky agent composition, which may be appropriately selected from publicly known ones as long as the tacky agent-forming composition can be cured. Examples thereof include a method including coating a solvent-free tacky agent composition or a solvent-including tacky agent composition that is to undergo drying, and polymerizing the monomer components included in the tacky agent-forming composition in the presence of a polymerization initiator or the like with curing means such as visible or UV ray irradiation, heating, electron beam irradiation, or the like.

No particular limitation is imposed on the concentration of the monomer components relative to the solvent in coating the solvent-including tacky agent composition, and the concentration thereof may be appropriately selected in accordance with a coater.

No particular limitation is imposed on the concentration of the polymerization initiator in the above polymerization, which may be appropriately selected in accordance with the intended purpose. However, the concentration of the polymerization initiator in terms of solid content is preferably from 0.5 parts by mass through 10 parts by mass and more preferably from 0.5 parts by mass through 3 parts by mass with the total amount of the monomer components being 100 parts by mass.

No particular limitation is imposed on the method of curing the tacky agent-forming composition, which may be appropriately selected in accordance with, for example, the type of the polymerization initiator. Examples thereof include photopolymerization, thermal polymerization, and the like.

The polymerization initiator is as described in the above section <Other components> of (Tacky agent-forming composition).

The tacky agent composition can be used as is. However, when the tacky agent composition is formed as a shaped product such as a film, a sheet, or the like, the tacky agent composition may include a substrate on a surface thereof. In this case, the tacky agent composition forms a tacky agent layer. The shaped product may have a configuration including the substrate and the tacky agent layer only on one surface of the substrate by applying the tacky agent composition to the one surface of the substrate. Alternatively, the shaped product may have a configuration including the substrate and the tacky agent layer on both surfaces of the substrate by applying the tacky agent composition to both of the surfaces of the substrate.

No particular limitation is imposed on the substrate, which may be appropriately selected from publicly known ones. Examples thereof include: paper such as high-density base paper (e.g., glassine paper and the like), clay coat paper, Kraft paper, Japanese paper, and high-quality paper; cloths such as cotton, staple fiber, chemical synthetic fiber, and non-woven fabric; films of, for example, cellophane, polyethylene, polyester, polyvinylchloride, acetal, polypropylene, polystyrene, polyvinylidene chloride, polybutadiene, polyacrylonitrile, and polylactic acid; and the like.

Also, from the viewpoint of reduction in environmental load, not only the tacky agent composition but also the substrate is preferably biodegradable. Examples of the biodegradable substrate include: polysaccharides such as 3-hydroxybutyric acid-3-hydroxyvaleric acid copolymers, microfibrillated cellulose, pullulan, and the like; glycol-fatty acid dicarboxylic acid copolymers such as polybutylene succinate, polybutylene succinate adipate, polyethylene succinate, polyethylene succinate adipate, and the like; polylactic acid; polycaprolactone; poly-γ-methylglutamate; thermoplastic polyvinyl alcohol; starch and modified polyvinyl alcohol; starch and naturally occurring resins; and chitosan and cellulose; and the like. Also, the substrate may be a composite of these materials.

Further, if necessary, the shaped product may include a release layer on the surface of the tacky agent layer.

No particular limitation is imposed on the material of the release layer, which may be appropriately selected from publicly known ones. Examples thereof include casein, dextrin, starch, carboxymethyl cellulose, methyl cellulose, ethyl cellulose, hydroxyethyl cellulose, polyvinyl alcohol, and the like. These may be used alone or in combination.

Also, the shaped product may be a laminate of a film or sheet of the tacky agent composition.

No particular limitation is imposed on the production method of the shaped product of the tacky agent composition, which may be produced in accordance with a routine method. Examples thereof include a method including coating the tacky agent composition onto the surface of the release layer, followed by drying to form the tacky agent layer, and further pasting the substrate thereto.

Alternatively, water, a solvent, or a solvent-free fluororesin or silicone resin may be coated on the substrate of the shaped product of the tacky agent composition, followed by thermal curing, curing by irradiation with ionizing radiation, or the like, thereby forming the release layer.

A publicly known coater can be used for coating the tacky agent composition onto the substrate.

No particular limitation is imposed on the coater, which may be appropriately selected from publicly known coaters. Examples thereof include multi-stage roll coaters, air knife coaters, bar coaters, offset gravure coaters, direct gravure coaters, reverse roll coaters, knife coaters, air knife coaters, bar coaters, slot die coaters, lip coaters, reverse gravure coaters, and the like.

Upon coating, the tacky agent composition may be appropriately diluted with water, a solvent, or the like so as to have a desired viscosity.

The tacky agent composition has excellent enzymatic degradability, biodegradability, and tackiness, and can be produced conveniently and inexpensively. Therefore, the tacky agent composition is suitably utilized in various industrial fields such as automobiles, packaging materials, building materials, IT fields, agricultural fields, medical fields, DIY-related fields, and the like. In addition, the tacky agent composition can contribute to reduction in environmental load.

### EXAMPLES

In the following, the present invention will be described in detail by way of Synthesis Examples, Working Examples, and Comparative Examples. However, the present invention should not be construed as being limited to these Synthesis Examples and Working Examples in any way.

### Synthesis Example 1: Synthesis of PLA Mixture

20 g (0.01 mol) of a diol of poly-L-lactic acid (PLA) (molecular weight as measured from a hydroxy value thereof: 2,000, product name: PLA2205, obtained from Shenzhen ESUN Industrial Co., Ltd.) was added to a 200-mL three-necked flask. Tetrahydrofuran (100 mL) was charged to the flask at 5° C., thereby completely dissolving the diol under stirring. Next, 2.4 g of triethylamine was slowly charged thereto. A reflux tube and a dropping funnel were attached to the flask, and the mixture was stirred in an ice bath. 1.1 g (0.012 mol) of acrylic acid chloride and 1.1 g (0.012 mol) of propionic acid chloride were diluted in tetrahydrofuran (30 mL) and slowly charged thereto via the dropping funnel. The resulting mixture was stirred for 2 hours as it was and then was heated to 40° C. and stirred for another 2 hours. After completion of reaction, tetrahydrofuran was removed with an evaporator, and was re-dissolved in acetone and stirred for 2 hours. The precipitated triethylamine hydrochloride was removed through suction filtration, followed by removing acetone with an evaporator, thereby producing a pale-yellow liquid as a PLA mixture (yield: 82% by mass).

The obtained pale-yellow liquid was measured with a Fourier transform infrared spectrophotometer (FT-IR, device name: Nicolet iS2, obtained from Thermo, the same was used in the following Synthesis Examples). As a result, a peak of a hydroxy group (OH) in the range of from 3,200 cm⁻¹ through 3,700 cm⁻¹ disappeared, and a peak of a double bond near 1, 625 cm⁻¹ was observed.

### Synthesis Example 2: Synthesis of PLA Mixture

20 g (0.01 mol) of a diol of poly-L-lactic acid (molecular weight as measured from a hydroxy value thereof: 2,000, product name: PLA2205, obtained from Shenzhen ESUN Industrial Co., Ltd.) was added to a 200-mL three-necked flask. Tetrahydrofuran (100 mL) was charged to the flask, thereby completely dissolving the diol under stirring. Next, 2.4 g of triethylamine was slowly charged thereto. A reflux tube and a dropping funnel were attached to the flask, and the mixture was stirred in an ice bath. 1.54 g (0.017 mol) of acrylic acid chloride and 0.66 g (0.007 mol) of propionic acid chloride were diluted in tetrahydrofuran (30 mL) and slowly charged thereto via the dropping funnel. The resulting mixture was stirred for 2 hours as it was and then was heated to 40° C. and stirred for another 2 hours. After completion of reaction, tetrahydrofuran was removed with an evaporator, and was re-dissolved in acetone and stirred for 2 hours. The precipitated triethylamine hydrochloride was removed through suction filtration, followed by removing acetone with an evaporator, thereby producing a pale-yellow liquid as a PLA mixture (yield: 82% by mass).

The obtained pale-yellow liquid was subjected to FT-IR analysis in the same manner as in hydroxy group in the range of from 3,200 cm⁻¹ through 3,700 cm⁻¹ disappeared, and a peak of a double bond near 1, 625 cm⁻¹ was observed.

### Synthesis Example 3: Synthesis of PLA Difunctional Acrylate

20 g (0.01 mol) of a diol of poly-L-lactic acid (molecular weight as measured from a hydroxy value thereof: 2,000, product name: PLA2205, obtained from Shenzhen ESUN Industrial Co., Ltd.) was added to a 200-mL three-necked flask. Tetrahydrofuran (100 mL) was charged to the flask, thereby completely dissolving the diol under stirring. Next, 2.4 g of triethylamine was slowly charged thereto. A reflux tube and a dropping funnel were attached to the flask, and the mixture was stirred in an ice bath. 2.2 g (0.024 mol) of acrylic acid chloride was diluted in tetrahydrofuran (30 mL) and slowly charged thereto via the dropping funnel. The resulting mixture was stirred for 2 hours as it was and then was heated to 40° C. and stirred for another 2 hours. After completion of reaction, tetrahydrofuran was removed with an evaporator, and was re-dissolved in acetone and stirred for 2 hours. The precipitated triethylamine hydrochloride was removed through suction filtration, followed by removing acetone with an evaporator, thereby producing a pale-yellow liquid as a PLA difunctional acrylate (yield: 80% by mass).

The obtained pale-yellow liquid was subjected to FT-IR analysis in the same manner as in hydroxy group in the range of from 3,200 cm⁻¹ through 3,700 cm⁻¹ disappeared, and a peak of a double bond near 1, 625 cm⁻¹ was observed.

### Synthesis Example 4: Synthesis of PCL Difunctional Acrylate

20 g (0.01 mol) of a diol of polycaprolactone (molecular weight as measured from a hydroxy value thereof: 2,000, product name: PLACCEL 230, obtained from DAICEL CORPORATION) was added to a 200-mL three-necked flask. Tetrahydrofuran (100 mL) was charged to the flask, thereby completely dissolving the diol under stirring. Next, 4.8 g of triethylamine was slowly charged thereto. A reflux tube and a dropping funnel were attached to the flask, and the mixture was stirred in an ice bath. 2.2 g (0.024 mol) of acrylic acid chloride was diluted in tetrahydrofuran (30 mL) and slowly charged thereto via the dropping funnel. The resulting mixture was stirred for 2 hours as it was and then was heated to 40° C. and stirred for another 2 hours. After completion of reaction, tetrahydrofuran was removed with an evaporator, and was re-dissolved in acetone and stirred for 2 hours. The precipitated triethylamine hydrochloride was removed through suction filtration, followed by removing acetone with an evaporator, thereby producing a pale-yellow liquid as a PLA difunctional acrylate (yield: 92% by mass).

The obtained pale-yellow liquid was subjected to FT-IR analysis in the same manner as in hydroxy group in the range of from 3,200 cm⁻¹ through 3,700 cm⁻¹ disappeared, and a peak of a double bond near 1, 625 cm⁻¹ was observed.

### Working Example 1

1 part by mass of a photopolymerization initiator (product name: Omnirad 1173, obtained from IGM Resins B.V) was added to 100 parts by mass of the PLA mixture obtained in Synthesis Example 1. The mixture was coated by being held between two transparent polyethylene (PET) films, followed by irradiation (1 J/cm²) with a UV conveyor, thereby producing a cured film.

### Comparative Example 1

A cured film was obtained in the same manner as in Working Example 1, except that unlike in Working Example 1, the PLA mixture obtained in Synthesis Example 1 was changed to the PLA mixture obtained in Synthesis Example 2.

### Comparative Example 2

A cured film was obtained in the same manner as in Working Example 1, except that unlike in Working Example 1, the PLA mixture obtained in Synthesis Example 1 was changed to the PLA difunctional acrylate obtained in Synthesis Example 3.

### Comparative Example 3

A cured film was obtained in the same manner as in Working Example 1, except that unlike in Working Example 1, the PLA mixture obtained in Synthesis Example 1 was changed to the PCL difunctional acrylate obtained in Synthesis Example 4.

### Test Example 1: Evaluation of Tackiness

The cured films obtained in Working Example 1 and Comparative Examples 1 to 3 were used to prepare respective test films (width: 10±0.5 mm, length: about 150 mm). One of the PET films was peeled off, and the exposed surface of the test film was pasted onto a stainless-steel plate (SUS304, thickness: 1 mm) as an adherend at a temperature of 23±1° C. and a humidity of 50±5%. Note that, the surface of the stainless-steel plate was previously roughened with sand paper (#400) so as to prevent the cured film (test film) from being peeled off from the stainless-steel plate. The transparent PET film was peeled off from the other surface of the test film (the opposite surface of the test film attached to the stainless-steel plate) and, instead, a polylactic acid film (width: 10 mm, length: 150 mm) was pressure-bonded thereto by moving a pressure-bonding roller back and force twice at a load of 2 kg. After the pressure bonding, the resulting film was left to stand for 20 minutes. A peel strength (mN/10 mm) between the polylactic acid film and the test film when the polylactic acid film was pulled in a direction oriented at 180 degrees with respect to the test film at a tensile speed of 300 mm/min using a tensile tester (AUTOGRAPH; AGX-50N, obtained from SHIMADZU CORPORATION). The measurement result was an average of the values measured three times. It is preferable that the value of the peel strength be higher. The results were presented in the following Table 1. Note that, in Comparative Examples 1 to 3, pasting was not possible because of lack of tackiness.

### Test Example 2: Measurement Method of Sol Fraction

The cured films obtained in Working Example 1 and Comparative Examples 1 to 3 were used to prepare respective test films (1 cm×1 cm). The mass of each of the test films (hereinafter may be referred to as an “initial mass”) was measured. The test film and acetone (20 mL) were placed in a glass vessel and airtightly sealed, followed by being left to stand at room temperature for one week. Subsequently, the glass vessel was unsealed, and the film content in the glass vessel was taken out through filtration, followed by drying and measuring the mass (hereinafter may be referred to as an “acetone-treated mass”).

The sol fraction (acetone-soluble component percentage) (%) was calculated in accordance with the following calculation formula 4. The results were presented in the following Table 1.

Sol fraction (%)=(Initial mass−Acetone-treated mass)/Initial mass×100 Formula 4

### Test Example 3: Evaluation of Enzymatic Degradability

The cured films obtained in Working Example 1 and Comparative Examples 1 to 3 were used to prepare respective test films (1 cm×1 cm). The mass of each of the test films (hereinafter may be referred to as an “initial mass”) was measured.

First, 3.8944 g of sodium dihydrogenphosphate dodecahydrate (NaH₂PO₄·12H₂O=358.14) was weighed and dissolved in pure water (500 mL). The solution was further treated with ultrasonic waves for 10 minutes or longer for dissolving the chemical, thereby preparing Solution 1. Also, 8.9535 g of disodium hydrogenphosphate dihydrate (Na₂HPO₄·2H₂O=156.01) was weighed and dissolved in pure water (500 mL). The solution was further treated with ultrasonic waves for 10 minutes or longer for dissolving the chemical, thereby preparing Solution 2. Solution 1 and Solution 2 were mixed to prepare a phosphate buffer.

Next, an exo-type lipase (product name: Lipase PS, obtained from Amano Enzyme Inc.) or an endo-type lipase (product name: Lipase B, obtained from Sigma-Aldrich) was adjusted to 10 U per 1 mg of a polymer of the test film using the prepared phosphate buffer.

A glass vessel was charged with the test film and 20 mL of the phosphate buffer including the exo-type lipase, the phosphate buffer including the endo-type lipase, or the phosphate buffer alone (including no lipase) as a control and was airtightly sealed and left to stand at 37° C. for 100 hours. Subsequently, the glass vessel was unsealed, and the film content in the glass vessel was taken out through filtration, followed by drying and measuring the mass (hereinafter may be referred to as an “enzyme-treated mass”).

The mass reduction rate (%) was calculated in accordance with the following calculation formula 5. The results were presented in the following Table 1.

Mass reduction rate (%)=(Initial mass−Enzyme-treated mass)/Initial mass×100 Formula 5

### Test Example 4: Evaluation of Glass Transition Temperature

The glass transition temperature (Tg) of the PLA mixture obtained in Synthesis Example 1, the PLA mixture obtained in Synthesis Example 2, the PLA difunctional acrylate obtained in Synthesis Example 3, or the PCL difunctional acrylate obtained in Synthesis Example 4 before polymerization in Working Example 1 and Comparative Examples 1 to 3 was determined as follows by a dynamic mechanical analyzer (DMA: Dynamic Mechanical Analysis, product name: RSA-3, obtained from TA Instruments). Specifically, the glass transition temperature (Tg, ° C.) was determined as a temperature at the maximum point of tan δ (loss modulus/storage modulus) obtained under measurement conditions of a sample size of 5 mm wide×20 mm long and a frequency of 1 MHZ. The results were presented in the following Table 1.

### Test Example 5: Evaluation of Inter Crosslinking Point Molecular Weight

The cured films obtained in Working Example 1 and Comparative Examples 1 to 3 were measured by a dynamic mechanical analyzer (DMA: Dynamic Mechanical Analysis, product name: RSA-3, obtained from TA Instruments), thereby calculating the inter crosslinking point molecular weight (Mc) from the following formula 2. The results were presented in the following Table 1.

### [Math. 3]

$${E}^{′} = \frac{dRT}{Mc} \qquad Formula 2$$

In formula 2, E′ denotes a rubber equilibrium modulus at a temperature that is equal to or higher than the glass transition temperature (Tg, ° C.) of the cured film, d denotes a density (g/m³) of the cured film, R denotes a gas constant (8.314 J/K/mol) in an ideal gas state equation, and T denotes an absolute temperature (K) at the local minimum of E′.

“E′” in formula 2 is a value measured by a dynamic mechanical analyzer (DMA: Dynamic Mechanical Analysis, product name: RSA-3, available from TA Instruments).

“d” in formula 2 was calculated in accordance with the following formula 3.

d=Weight=Volume Formula 3

In formula 3, “Weight” is a weight measured by preparing a sample of the cured film cut out into a square of 1 cm per side and weighing the prepared sample with a precision balance, and “Volume” is a volume calculated by measuring the thickness of the sample.

TABLE 1

| Composition | | | | Comp. | Comp. | Comp. |
|---|---|---|---|---|---|---|
| (parts by mass) | | | Ex. 1 | Ex. 1 | Ex. 2 | Ex. 3 |
| PLA mixture | | | 100 | — | — | — |
| (Synthesis Example 1, Molecular Weight 2,000) | | | | | | |
| PLA mixture | | | — | 100 | — | — |
| (Synthesis Example 2, Molecular Weight 2,000) | | | | | | |
| PLA difunctional acrylate | | | — | — | 100 | — |
| (Synthesis Example 3, Molecular Weight 2,000) | | | | | | |
| PCL difunctional acrylate | | | — | — | — | 100 |
| (Synthesis Example 4, Molecular Weight 2,000) | | | | | | |
| Photoinitiator | | | 1 | 1 | 1 | 1 |
| Evaluation | Sol fraction (%) | | 67 | 25 | 12 | 7 |
| Results | Tg (° C.) | | −10 | −8 | −2 | −50 |
| | Inter crosslinking point | | 19,500 | 2,100 | 900 | 300 |
| | molecular weight (Mc) | | | | | |
| | Tackiness (mN/10 mm) | | 50 | None | None | None |
| | Enzymatic | No enzyme | 8 | 4.7 | 3.6 | 3.3 |
| | degradability | (buffer alone) | | | | |
| | (Mass reduction | Exo-type lipase | 32.4 | 11.4 | 4.1 | 5.2 |
| | rate (%)) | (Lipase PS) | | | | |
| | | Endo-type lipase | 12.6 | 7.9 | 7.6 | 4.1 |
| | | (Lipase B) | | | | |

Comparison of Working Example 1 with Comparative Example 1 and Comparative Example 2 suggested that tackiness was more favorable when the crosslinking density was low, i.e., the inter crosslinking point molecular weight was high. Also, comparison of Working Example 1 with Comparative Example 3 indicated that no tackiness was obtained in the case of the polycaprolactone backbone. Also, the mass reduction rate by the action of the exo-type lipase (Lipase PS) and the endo-type lipase (Lipase B) in Working Example 1 and Comparative Examples 1 to 3 was higher than in the absence of the enzyme, suggesting that the polyester structure was degraded by lipase. Lipase B is of an exo-type and degrades the crosslinked structure itself. Thus, Lipase B also degraded the cured film of Comparative Example 2 having a high crosslinking density. Degradability remained unchanged even if the crosslinking density decreased and the sol components increased. Meanwhile, the exo-type lipase (Lipase PS) had degradability increasing as the sol components increased. Thereby, Working Example 1 was suggested to have both satisfactory tackiness and satisfactory enzymatic degradability.

### INDUSTRIAL APPLICABILITY

The tacky agent-forming composition of the present invention is used for production of the tacky agent composition and can be cured by the action of heat, light, or the like. The tacky agent-forming composition can impart excellent enzymatic degradability, biodegradability, and tackiness to the tacky agent composition obtained therefrom. In addition, the tacky agent-forming composition can form the tacky agent composition conveniently and inexpensively, and thus is suitably used for production of the tacky agent composition.

Also, the tacky agent composition has excellent enzymatic degradability, biodegradability, and tackiness, and can be produced conveniently and inexpensively. Therefore, the tacky agent composition is suitably utilized in various industrial fields such as automobiles, packaging materials, building materials, IT fields, agricultural fields, medical fields, DIY-related fields, and the like. In addition, the tacky agent composition can contribute to reduction in environmental load.

The present international application claims priority to Japanese Patent Application No. 2021-134169, filed on Aug. 19, 2021, the contents of Japanese Patent Application No. 2021-134169 are incorporated herein by reference in their entirety.

1. A tacky agent-forming composition, comprising:
a polylactic acid structure-including monofunctional (meth)acrylic monomer;
a polylactic acid structure-including polyfunctional (meth)acrylic monomer; and
a polylactic acid structure-including non-functional compound, wherein
a content of the polylactic acid structure-including non-functional compound is 10% by mole or more.

2. A production method of a tacky agent-forming composition, the production method comprising:
reacting (meth)acrylic acid chloride and saturated fatty acid chloride with a polylactic acid structure-including diol.

3. The production method of the tacky agent-forming composition according to claim 2, wherein
a molecular weight of the polylactic acid structure-including diol is 1,000 or higher, as measured from a hydroxy value thereof.

4. A tacky agent composition, comprising:
a cured product of the tacky agent-forming composition according to claim 1.

5. The tacky agent composition according to claim 4, wherein
a sol fraction of the tacky agent composition that is acetone soluble is 30% or more.

6. The tacky agent composition according to claim 4, wherein
the tacky agent composition is degraded by an exo-type lipase.

7. The tacky agent composition according to claim 5, wherein
the tacky agent composition is degraded by an exo-type lipase.
